(19) United States
(12) Patent Application Publication
(10) Pub. No.: US 2022/0149684 A1
(43) Pub. Date: May 12, 2022

(54) AXIAL GAP MOTOR AND RADIAL GAP MOTOR

(71) Applicant: SEIKO EPSON CORPORATION, Tokyo (JP)

(72) Inventor: Kuniaki TANAKA, MATSUMOTO-SHI (JP)

(21) Appl. No.: 17/520,761

(22) Filed: Nov. 8, 2021

(30) Foreign Application Priority Data
Nov. 10, 2020 (JP) 2020-187139

(51) Int. Cl. H02K 1/2795; H02K 1/18; H02K 21/24

(52) U.S. Cl. CPC H02K 1/2795; H02K 21/24; H02K 1/182

(57) ABSTRACT

An axial gap motor includes a stator including a coil and a rotor disposed to be separated from the stator and configured to rotate around a rotating shaft. The rotor includes a first magnet and a second magnet adjacent to the first magnet. The first magnet includes a projection provided at an end portion in a circumferential direction in a plan view from an axial direction of the rotating shaft. The second magnet includes a recess provided at an end portion in the circumferential direction in the plan view from the axial direction and fitting with the projection.

The present application is based on, and claims priority from JP Application Serial Number 2020-187139, filed Nov. 10, 2020, the disclosure of which is hereby incorporated by reference herein in its entirety.

### BACKGROUND

### 1. Technical Field

The present disclosure relates to an axial gap motor and a radial gap motor.

### 2. Related Art

For example, JP-A-2010-284036 (Patent Literature 1) discloses an axial gap motor including a permanent magnet row Halbach-arrayed in the circumferential direction from a rotating shaft and an armature coil winding disposed to be opposed to the permanent magnet row.

However, since an end portion in the circumferential direction of a magnet is linear, the magnet is likely to deviate in the radial direction. If the magnet deviates in the radial direction, an overlapping area of a coil and the magnet decreases and a magnetic characteristic is deteriorated.

### SUMMARY

An axial gap motor includes: a stator including a coil; and a rotor disposed to be separated from the stator and configured to rotate around a rotating shaft. The rotor includes a first magnet and a second magnet adjacent to the first magnet. The first magnet includes a projection provided at an end portion in a circumferential direction in a plan view from an axial direction of the rotating shaft. The second magnet includes a recess provided at an end portion in the circumferential direction in the plan view from the axial direction and fitting with the projection.

A radial gap motor includes: a stator including a coil; and a rotor disposed to be separated from the stator and configured to rotate around a rotating shaft. The rotor includes a first magnet and a second magnet adjacent to the first magnet. The first magnet includes a projection provided at an end portion in a circumferential direction in a plan view from a radial direction of the rotating shaft. The second magnet includes a recess provided at an end portion in the circumferential direction in the plan view from the radial direction and fitting with the projection.

### BRIEF DESCRIPTION OF THE DRAWINGS

FIG. 1 is a sectional view showing the structure of an axial gap motor.

FIG. 2 is a perspective view showing the configuration of a magnet body.

FIG. 3 is a plan view showing the configuration of the magnet body.

FIG. 4 is a sectional view showing a positional relation between the magnet body and a stator.

FIG. 5 is a flowchart showing a manufacturing method for the magnet body.

FIG. 6 is a plan view showing a part of the manufacturing method for the magnet body.

FIG. 7 is a side view showing a part of the manufacturing method for the magnet body.

FIG. 8 is a side view showing a part of the manufacturing method for the magnet body.

FIG. 9 is a plan view showing a part of the manufacturing method for the magnet body.

FIG. 10 is a graph showing a magnetic flux density waveform.

FIG. 11 is a perspective view showing the configuration of a radial gap motor.

FIG. 12 is a plan view showing the configuration of a magnet body in a modification.

FIG. 13 is a plan view showing the configuration of a magnet body in a modification.

FIG. 14 is a plan view showing the configuration of a magnet body in a modification.

FIG. 15 is a plan view showing the configuration of a magnet body in a modification.

FIG. 16 is a plan view showing the configuration of a magnet body in a modification.

FIG. 17 is a plan view showing the configuration of a magnet body in a modification.

### DESCRIPTION OF EXEMPLARY EMBODIMENTS

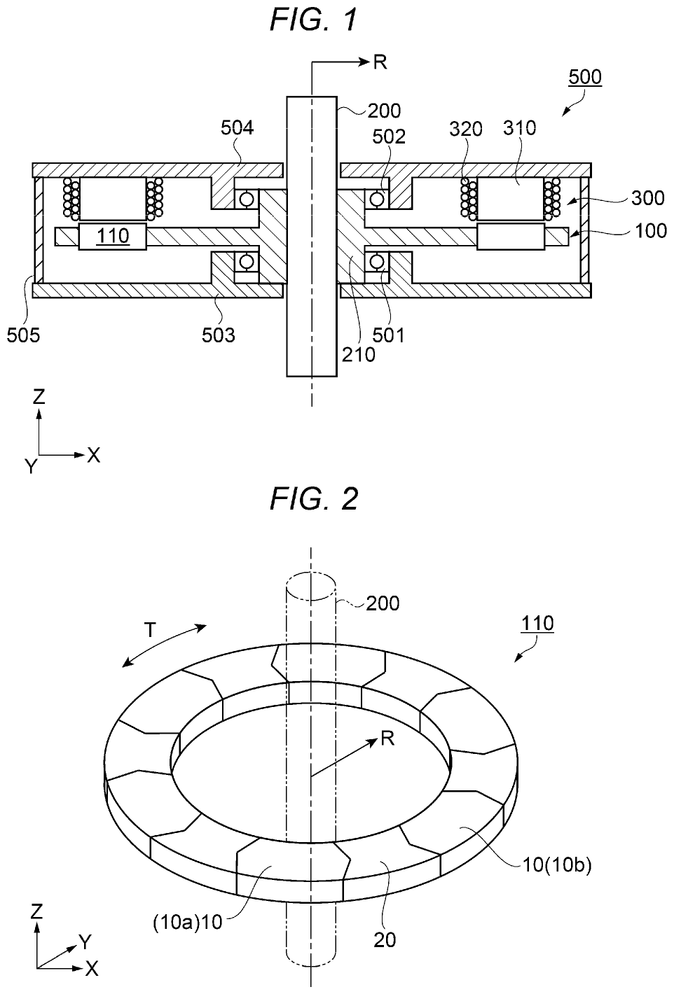

First, the configuration of an axial gap motor 500 in an embodiment is explained with reference to FIG. 1.

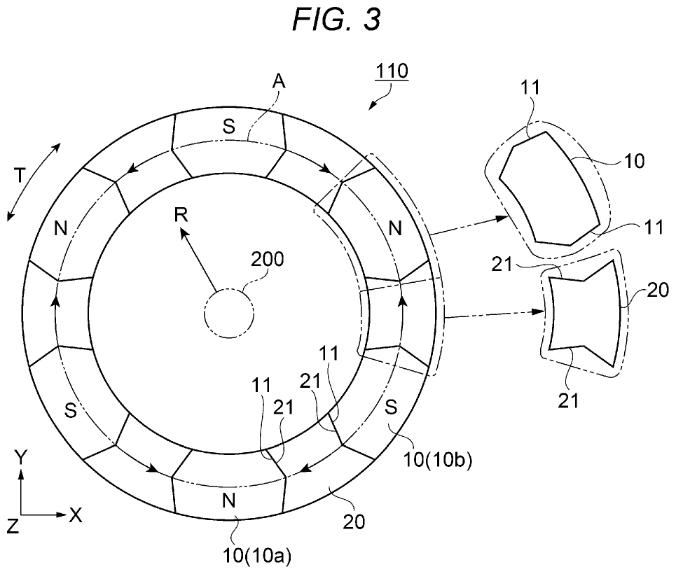

As shown in FIG. 1, the axial gap motor 500 includes a magnet body 110 including first magnets 10 and second magnets 20 (see FIGS. 2 and 3), which are permanent magnets. A rotor 100 that rotates around a rotating shaft 200 is disposed in the axial gap motor 500. The axial gap motor 500 includes a stator 300 disposed around the rotating shaft 200 and disposed to be separated from the rotor 100.

As shown in FIG. 1, the upward direction of the rotating shaft 200 is represented as Z and the radial direction of the rotating shaft 200 is represented as X and Y. The radial direction of the rotating shaft 200 is sometimes referred to as R. The same applies in the drawings following FIG. 1. A direction along the Z direction is sometimes referred to as “upper” and the opposite direction of the direction is referred to as “lower”.

The rotating shaft 200 is a columnar body. The rotating shaft 200 may be a hollow rotating shaft 200. In the axial gap motor 500, the thickness in the Z direction tends to be small and the dimension in the radial direction R tends to be large. Therefore, the rotating shaft 200 may be increased in size in the radial direction and may be formed as a hollow shaft to insert wires to the axial gap motor 500 through the inside of the rotating shaft 200.

In the rotor 100 fixed to the rotating shaft 200 as the center, pluralities of the first magnets 10 and the second magnets 20 are disposed in the circumference direction near the terminal end in the radial direction R. The numbers and the disposition of the first magnets 10 and the second magnets 20 are decided by the number of phases and the number of poles of the axial gap motor 500. In the center of the rotor 100, a fixed section 210, to which the rotating shaft 200 is fixed, is disposed. The rotating shaft 200 is pressed into and fixed to the fixed section 210.

A first case 503 and a second case 504 are attached to the fixed section 210 via bearings 501 and 502. The first case 503 and the second case 504 are combined by a side surface case 505 to configure a motor case. Therefore, the rotating shaft 200 and the rotor 100 fixed to the rotating shaft 200 via the fixed section 210 are held to be rotatable with respect to the motor case.

The stator 300 is incorporated in the first case 503 and the second case 504. A core 310 is disposed in the stator 300 to be opposed to the first magnets 10 and the second magnets 20 of the rotor 100. A coil 320 that generates a magnetic force is wound on the outer circumference of the core 310. Specifically, the stator 300 is disposed such that the core 310 is separated from the first magnets 10 and the second magnets 20 by a predetermined gap.

As shown in FIGS. 2 and 3, the magnet body 110 is formed in an annular shape by combining the first magnets 10 and the second magnets 20 adjacent to the first magnets 10. Specifically, in the magnet body 110, the first magnets 10, which are permanent magnets and function as main magnetic pole magnets, and the second magnets 20, which are permanent magnets and function as sub-magnetic pole magnets, are alternately arrayed in a circumferential direction T of the rotating shaft 200.

As shown in FIG. 3, arrows of the second magnets 20 indicate magnetization directions. The first magnets 10 and the second magnets 20 are disposed in a Halbach array. The first magnets 10 are disposed such that N-pole first magnets 10a and S-pole first magnets 10b alternately appear in the circumferential direction T.

The first magnets 10 and the second magnets 20 are formed to have arcuate shapes on sides to be an outer circumference and an inner circumference when combined and are fit in the circumferential direction T and formed to be combined in an annular shape. In each of the first magnets 10, a projection 11 is formed at an end portion in the circumferential direction T in a plan view from the axial direction of the rotating shaft 200. In this embodiment, the end portion of the first magnet 10 is formed in a convex triangular shape formed by crossing at least two straight lines.

In each of the second magnets 20, a recess 21 fitting with the projection 11 of the first magnet 10 is formed at an end portion in the circumferential direction T in the plan view from the axial direction of the rotating shaft 200. In this embodiment, the end portion of the second magnet 20 is formed in a concave triangular shape. That is, the triangular projection 11 of the first magnet 10 and the triangular recess 21 of the second magnet 20 are fit and combined. The annular magnet body 110 is configured by combining the N-pole first magnets 10a, the second magnets 20, and the S-pole first magnets 10b in this order.

As shown in FIG. 3, an imaginary line A connecting the centers of gravity of the first magnets 10 and the centers of gravity of the second magnets 20 is substantially circular in a plan view from the axial direction of the rotating shaft 200. In this way, the imaginary line A of the center of gravity of the magnet body 110 of the axial gap motor 500 is substantially circular and the first magnets 10 and the second magnets 20 are fit with each other. Therefore, it is possible to suppress the first magnets 10 and the second magnets 20 from deviating in the radial direction with respect to the rotating shaft 200. It is possible to suppress a magnetic characteristic from being deteriorated.

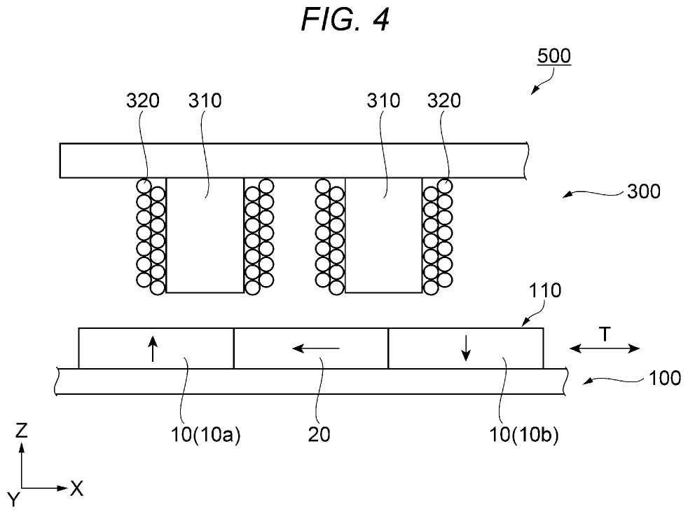

A positional relation between the magnet body 110 and the stator 300 is explained with reference to FIG. 4.

As shown in FIG. 4, the magnet body 110 is disposed by combining the N-pole first magnet 10a, the second magnet 20, and the S-pole first magnet 10b in order. The core 310, on which the coil 320 is wound, is disposed in a position opposed to the magnet body 110.

In the magnet body 110, magnetization directions are indicated by arrows. For example, in FIG. 4, the N-pole first magnet 10a is magnetized from the lower side to the upper side of the Z axis. That is, an N pole appears on the upper side of the first magnet 10a. The S-pole first magnet 10b is magnetized from the upper side to the lower side of the Z axis. That is, an S pole appears on the upper side of the first magnet 10b. For example, in FIG. 4, the second magnet 20 is magnetized from the right side to the left side in the circumferential direction T.

As explained above, the projection 11 in the circumferential direction T of the first magnet 10 and the recess 21 in the circumferential direction T of the second magnet 20 fit with each other. Therefore, it is possible to prevent the center of gravity of the first magnet 10 and the center of gravity of the second magnet 20 from being easily deviating. That is, a center axis B of the first magnet 10 and the second magnet 20 and a center axis B of the stator 300 coincide (see FIG. 9). Consequently, it is possible to suppress a planarly overlapping area of the first magnet 10 and the second magnet 20 and the coil 320 from decreasing. Magnetic fluxes of the first magnet 10 and the second magnet 20 effectively flow into the stator 300. As a result, it is possible to sufficiently achieve a magnetic characteristic.

The shape of the projection 11 is a triangular shape, specifically, a triangular shape projecting in the circumferential direction T from the end portion of the first magnet 10. Therefore, the projection 11 can be formed by only machining at least two surfaces at the end portion and can be easily formed. Since the shape of the projection 11 is not a fine shape, the projection 11 has strength. It is possible to prevent the first magnet 10 and the second magnet 20 from being easily cracked.

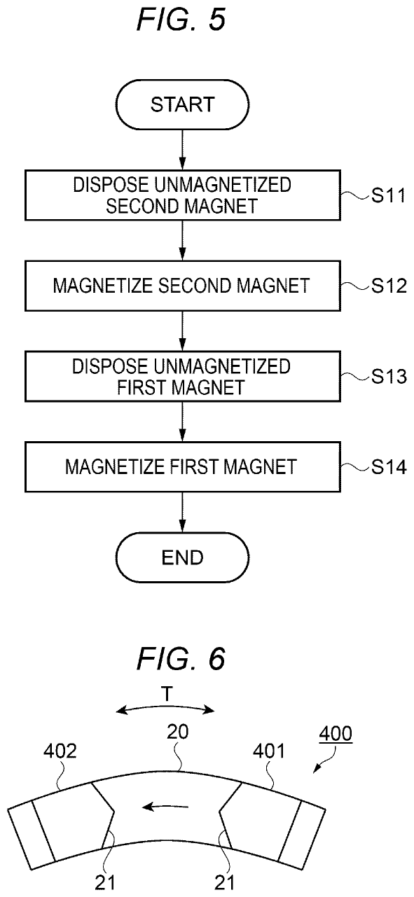

A manufacturing method for the magnet body 110 is explained with reference to FIGS. 5 to 9.

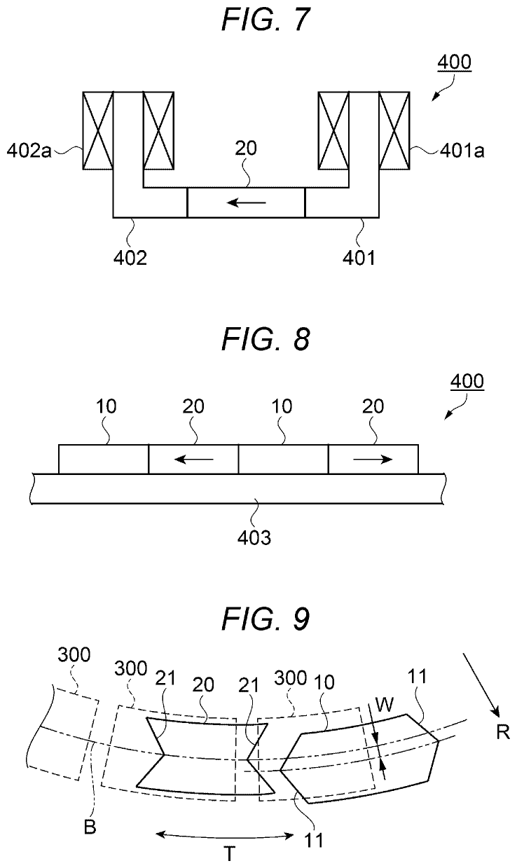

As shown in FIG. 5, in step S11, an unmagnetized second magnet 20 is disposed in a magnetization device 400. Specifically, as shown in FIGS. 6 and 7, the unmagnetized second magnet 20 is sandwiched using magnetization yokes 401 and 402 of the magnetization device 400. Since the magnetization yokes 401 and 402 are formed to fit in the shape of the recess 21 of the second magnet 20, it is possible to easily lay out the second magnet 20 and the magnetization yokes 401 and 402.

In step S12, magnetization work for the second magnet 20 is performed. Specifically, as shown in FIG. 7, an electric current is fed to coils 401a and 402a wound on the magnetization yokes 401 and 402 to magnetize the second magnet 20. A magnetic field is formed by feeding the electric current from the magnetization yoke 401 to the magnetization yoke 402. The second magnet 20 can be magnetized such that a magnetization direction of the second magnet 20 is from the right side to the left side in FIG. 7.

In step S13, an unmagnetized first magnet 10 is disposed. Specifically, as shown in FIG. 8, on a stage 403 of the magnetization device 400, the first magnet 10 is disposed between the second magnet 20 and the second magnet 20, which are the sub-magnetic pole magnets. First, the second magnets 20, which are the sub-magnetic pole magnets, are stuck on the stage 403. Subsequently, the unmagnetized first magnet 10 is fit in between the second magnet 20 and the second magnet 20. At this time, the unmagnetized first magnet 10 is fixed between the magnetized second magnets 20 by an attraction force. Therefore, it is possible to fix the first magnet 10 between the second magnet 20 and the second magnet 20 without using a fixing jig or the like. Further, since the projections 11 are fit in the recesses 21 of the second magnets 20, the first magnet 10 can be laid out and fixed between the second magnet 20 and the second magnet 20 (see FIG. 9).

In step S14, magnetization work for the first magnet 10 is performed. Specifically, although not shown, a magnetization yoke (not shown) for the first magnet 10 is disposed in the up-down direction of the first magnet 10 and an electric current is fed in a direction in which the first magnet 10 is desired to be magnetized. Consequently, as shown in FIG. 4, the N-pole first magnet 10a is magnetized from the lower side to the upper side. On the other hand, as shown in FIG. 4, the S-pole first magnet 10b is magnetized from the upper side to the lower side.

By performing the magnetization work in this way, it is possible to form the magnet body 110 in a Halbach array in which the N-pole first magnet 10a, the second magnet 20, and the S-pole first magnet 10b are arrayed in this order. As shown in FIG. 9, the projection 11 of the first magnet 10 is fit in the recess 21 of the second magnet 20. Therefore, even if a rotating force acts on the first magnet 10, it is possible to restrict deviation W in the radial direction R between the first magnet 10 and the second magnet 20. Consequently, it is possible to suppress positional deviation from the stator 300 (in particular, the coil 320 (see FIG. 4)) disposed to be opposed to the magnet body 110. An overlapping area in a plan view of the first magnet 10 and the second magnet 20 and the coil 320 is suppressed from decreasing. As a result, it is possible to suppress a magnetic characteristic from being deteriorated. For example, it is possible to improve assemblability compared with a method of respectively magnetizing the first magnets 10 and the second magnets 20 and, thereafter, combining the first magnets 10 and the second magnets 20 to form the rotor 100.

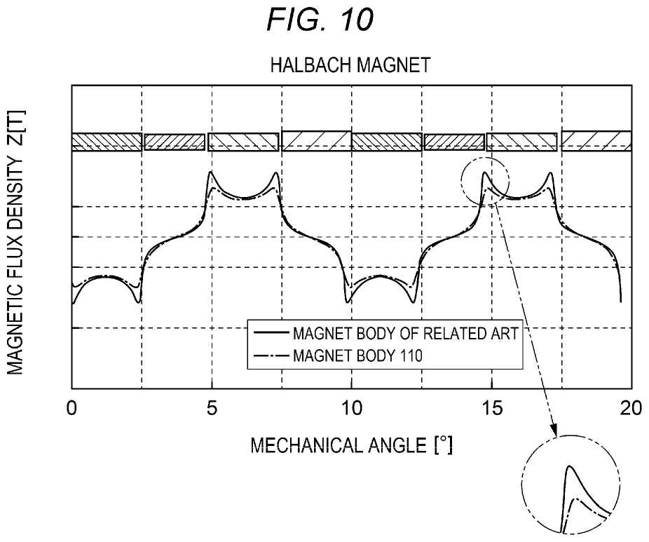

A magnetic flux density waveform obtained when the magnet body 110 in this embodiment is used is explained with reference to FIG. 10.

In a graph of FIG. 10, the vertical axis indicates magnetic flux density (T) and the horizontal axis indicates a mechanical angle)(°. Waveforms shown in FIG. 10 indicate waveforms of magnetic flux densities changed in two kinds of magnet bodies, that is, the magnet body of the related art and the magnet body 110 in the embodiment.

As shown in FIG. 10, it is seen that, in the magnet body 110 in the embodiment, a change in a magnetic flux is gentler compared with the magnet body of the related art in a boundary between the first magnet 10 and the second magnet 20. That is, in the magnet body 110 in the embodiment, since the change of the magnetic flux is gentle in the boundary between the first magnet 10 and the second magnet 20, fluctuation of the magnetic flux density waveform is small. A sudden change of magnetic fluxes of adjacent magnets is suppressed. Accordingly, since the magnetic flux density distribution approaches an ideal Sin waveform shape, it is possible to provide the axial gap motor 500 with reduced cogging torque and small rotation unevenness.

As explained above, the axial gap motor 500 in this embodiment includes the stator 300 including the coil 320 and the rotor 100 disposed to be separated from the stator 300 and configured to rotate around the rotating shaft 200. The rotor 100 includes the first magnet 10 and the second magnet 20 adjacent to the first magnet 10. The first magnet 10 includes the projection 11 provided at the end portion in the circumferential direction T in the plan view from the axial direction of the rotating shaft 200. The second magnet 20 includes the recess 21 provided at the end portion in the circumferential direction T in the plan view from the axial direction and fitting with the projection 11.

With this configuration, since the projection 11 in the circumferential direction T of the first magnet 10 and the recess 21 in the circumferential direction T of the second magnet 20 fit with each other, it is possible to prevent the center of gravity of the first magnet 10 and the center of gravity of the second magnet 20 from easily deviating. Accordingly, it is possible to suppress a planar overlapping area of the first magnet 10 and the second magnet 20 and the coil 320 from decreasing. It is possible to suppress a magnetic characteristic from being deteriorated.

It is preferable that the projection 11 is formed in a triangular shape formed by crossing at least two straight lines. With this configuration, since the shape of the projection 11 is a triangular shape, specifically, a triangular shape projecting in the circumferential direction T from the end portion of the first magnet 10, the projection 11 can be formed by only machining at least two surfaces at the end portion and can be easily formed. Since the shape of the projection 11 is not a fine shape, the projection 11 has strength. It is possible to prevent the first magnet 10 and the second magnet 20 from being easily cracked.

It is preferable that the imaginary line A connecting the centers of gravity of the first magnets 10 and the centers of gravity of the second magnets 20 is substantially circular in the plan view from the axial direction. With this configuration, since the first magnet 10 and the second magnet 20 are fit with each other such that their centers of gravity are made the substantial circular shape, it is possible to suppress the first magnet 10 and the second magnet 20 from deviating in the radial direction R with respect to the rotating shaft 200. It is possible to suppress a magnetic characteristic from being deteriorated.

It is preferable that the first magnet 10 is a main magnetic pole magnet and the projections 11 are provided at both end portions in the circumferential direction T of the first magnet 10 and the second magnet 20 is a sub-magnetic pole magnet and the recesses 21 are provided at both end portions in the circumferential direction T of the second magnet 20. With this configuration, since the recesses 21 are provided in the second magnet 20, which is the sub-magnetic pole magnet, and the projections 11 fitting in the recesses 21 are provided in the first magnet 10, which is the main magnetic pole magnet, it is possible to set the area of the magnetic 10 including the projections 11 larger than the area of the second magnet 20 including the recesses 21. Accordingly, it is possible to suppress a magnetic characteristic from being affected.

Considering processes up to a magnetization process, it is possible to provide the axial gap motor 500 that is easily assembled, has a gentle change of a magnetic flux distribution in a rotating direction, and has small cogging.

Modifications of the embodiment are explained below.

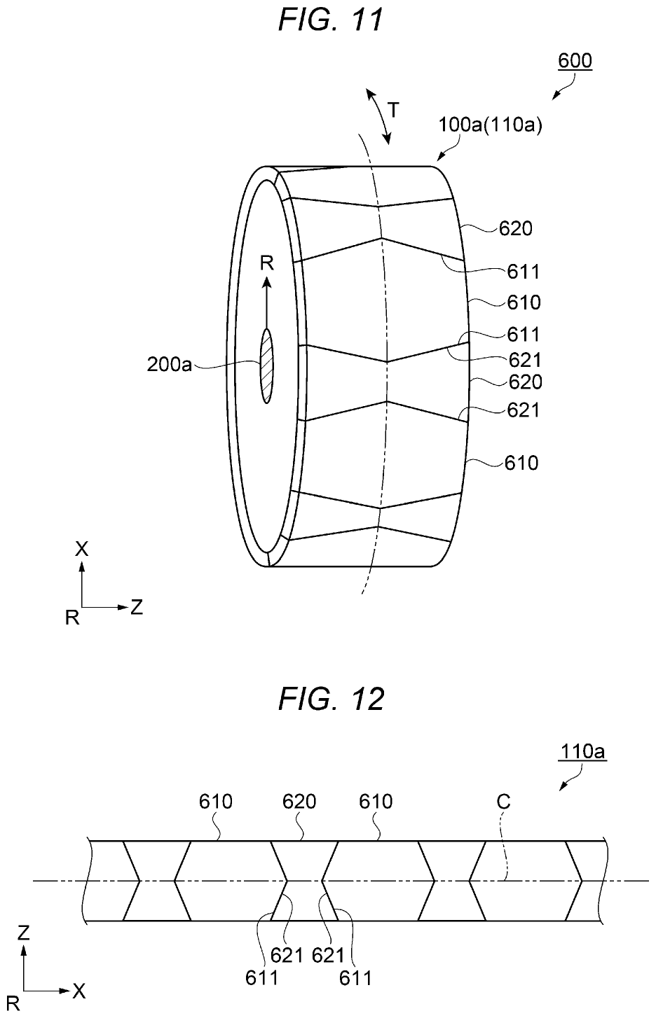

The configuration of the magnet body 110 obtained by combining the first magnet 10 including the projection 11 and the second magnet 20 including the recess 21 is not limited to be applied to the axial gap motor 500 but may be applied to, for example, a radial gap motor 600. FIG. 11 is a perspective view showing the configuration of the radial gap motor 600.

The radial gap motor 600 is a motor having a gap in the radial direction R of a rotating shaft 200a. FIG. 1 can be referred to about a part of the structure of the radial gap motor 600. As shown in FIG. 11, the radial gap motor 600 includes a rotor 100a including first magnets 610 and second magnets 620 and configured to rotate around the rotating shaft 200a. The radial gap motor 600 includes a stator disposed to be separated from the rotor 100a and including a not-shown coil.

The rotor 100a includes the first magnets 610 and the second magnets 620 adjacent to the first magnets 610. Each of the first magnets 610 includes a projection 611 provided at an end portion in the circumferential direction T in a plan view from the radial direction R of the rotating shaft 200a. Each of the second magnets 620 includes a recess 621 provided at an end portion in the circumferential direction T in the plan view from the radial direction R of the rotating shaft 200a and fitting with the projection 611.

A magnet body 110a is formed in an annular shape by combining the first magnets 610 and the second magnets 620 adjacent to the first magnets 610. Specifically, in the magnet body 110a, the first magnets 610, which are permanent magnets and function as main magnetic pole magnets, and the second magnets 620, which are permanent magnets and function as sub-magnetic pole magnets, are alternately arrayed in the circumferential direction T of the rotating shaft 200a.

The first magnets 610 and the second magnets 620 are disposed in a Halbach array. The first magnets 610 and the second magnets 620 are fit in the circumferential direction T and formed to be combined in an annular shape. The end portion of each of the first magnets 610 is formed in a convex triangular shape formed by crossing at least two straight lines. The end portion of each of the second magnets 620 is formed in a concave triangular shape. That is, the triangular projection 611 of the first magnet 610 and the triangular recess 621 of the second magnet 620 are fit and combined.

As shown in FIG. 12, in the plan view from the radial direction R of the rotating shaft 200a, an imaginary line C connecting the centers of gravity of the first magnets 610 and the centers of gravity of the second magnets 620 is linear. FIG. 12 is a diagram in which the first magnets 610 and the second magnets 620 are spread and arranged. In this way, the imaginary line C of the center of gravity of the magnet body 110a of the radial gap motor 600 is linear and the first magnets 610 and the second magnets 620 are fit with each other. Therefore, it is possible to suppress the first magnets 610 and the second magnets 620 from deviating in the axial direction of the rotating shaft 200a. It is possible to suppress a magnetic characteristic from being deteriorated.

In this way, the radial gap motor 600 includes the stator including the coil and the rotor 100a disposed to be separated from the stator and configured to rotate around the rotating shaft 200a. The rotor 100a includes the first magnet 610 and the second magnet 620 adjacent to the first magnet 610. The first magnet 610 includes the projection 611 provided at the end portion in the circumferential direction T in the plan view from the radial direction R of the rotating shaft 200a. The second magnet 620 includes the recess 621 provided at the end portion in the circumferential direction T in the plan view from the radial direction R and fitting with the projection 611.

With this configuration, since the projection 611 in the circumferential direction T of the first magnet 610 and the recess 621 in the circumferential direction T of the second magnet 620 fit with each other, it is possible to prevent the center of gravity of the first magnet 610 and the center of gravity of the second magnet 620 from easily deviating. Accordingly, it is possible to suppress a planar overlapping area of the first magnet 610 and the second magnet 620 from decreasing. It is possible to suppress a magnetic characteristic from being deteriorated.

It is preferable that the projection 611 is formed in a triangular shape formed by crossing at least two straight lines. With this configuration, since the shape of the projection 611 is a triangular shape, specifically, a triangular shape projecting in the circumferential direction T from the end portion of the first magnet 610, the projection 611 can be formed by only machining at least two surfaces at the end portion and can be easily formed. Since the shape of the projection 611 is not a fine shape, the projection 611 has strength. It is possible to prevent the first magnet 610 and the second magnet 620 from being easily cracked.

It is preferable that the imaginary line C connecting the center of gravity of the first magnet 610 and the center of gravity of the second magnet 620 is linear in the plan view from the axial direction R. With this configuration, since the first magnet 610 and the second magnet 620 are fit with each other such that their centers of gravity are made the linear shape, it is possible to suppress the first magnet 610 and the second magnet 620 from deviating in the direction of the rotating shaft 200a. It is possible to suppress a magnetic characteristic from being deteriorated.

It is preferable that the first magnet 610 is a main magnetic pole magnet and the projections 611 are provided at both end portions in the circumferential direction T of the first magnet 610 and the second magnet 620 is a sub-magnetic pole magnet and the recesses 621 are provided at both end portions in the circumferential direction T of the second magnet 620. With this configuration, since the recesses 621 are provided in the second magnet 620, which is the sub-magnetic pole magnet, and the projections 611 fitting in the recesses 621 are provided in the first magnet 610, which is the main magnetic pole magnet, it is possible to set the area of the magnetic 610 including the projections 611 larger than the area of the second magnet 620 including the recesses 621. Accordingly, it is possible to suppress a magnetic characteristic from being affected.

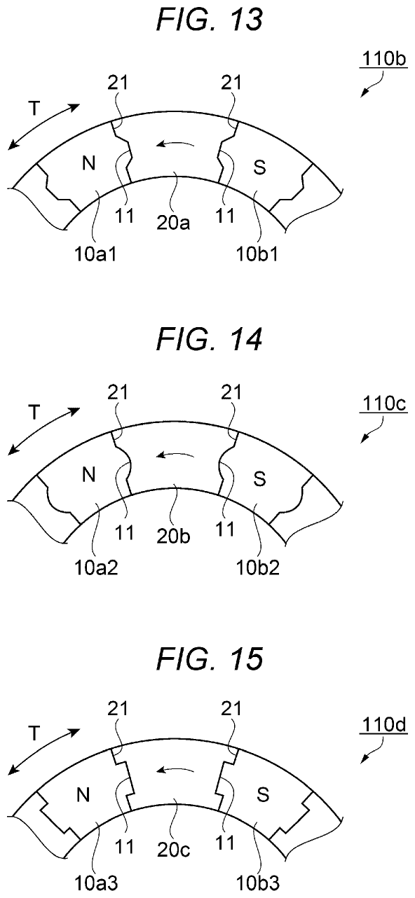

The next modification is explained. The projection 11 is not limited to be formed in the triangular shape and may be formed in a trapezoidal shape. FIG. 13 is a plan view showing a part of the configuration of a magnet body 110b in a modification. The magnet body 110b in the modification is assembled by fitting first magnets 10a1 and 10b1, both end portions in the circumferential direction T of which are formed in a convex trapezoidal shape, and a second magnet 20a, both end portions in the circumferential direction T of which is formed in a concave trapezoidal shape.

In this way, it is preferable that the projection 11 is formed in the trapezoidal shape. With this configuration, since the shape of the projection 11 is the trapezoidal shape, it is possible to set an angle forming the trapezoidal shape to an obtuse angle. It is possible to prevent the first magnets 10a1 and 10b1 and the second magnet 20a from being easily cracked. The projection 611 in the radial gap motor 600 explained in the above modification may be formed in the same shape.

The projection 11 is not limited to be formed in the triangular shape and may be formed in an arcuate shape. FIG. 14 is a plan view showing a part of the configuration of a magnet body 110c in a modification. The magnet body 110c in the modification is assembled by fitting first magnets 10a2 and 10b2, both end portions in the circumferential direction T of which are formed in a convex arcuate shape, and a second magnet 20b, both end portions in the circumferential direction T of which are formed in a concave arcuate shape.

Consequently, since the shape is the arcuate shape, for example, when an unmagnetized main magnetic pole magnet is inserted into between magnetized sub-magnetic pole magnets, it is possible to easily insert the unmagnetized main magnetic pole magnet. The projection 611 in the radial gap motor 600 explained in the above modification may be formed in the same shape.

The projection 11 is not limited to be formed in the triangular shape and may be formed in a rectangular shape (specifically, a square shape). FIG. 15 is a plan view showing a part of the configuration of a magnet body 110d in a modification. The magnet body 110d in the modification is assembled by fitting first magnets 10a3 and 10b3, both end portions in the circumferential direction T of which are formed in a convex square shape, and a second magnet 20c, both end portions in the circumferential direction T of which are formed in a concave square shape. The projection 611 in the radial gap motor 600 explained in the above modification may be formed in the same shape.

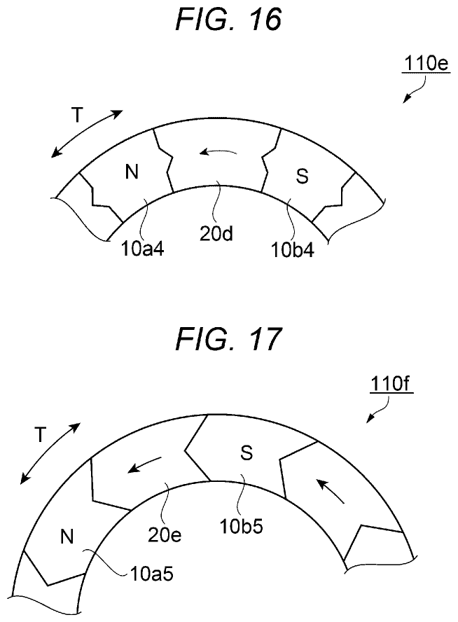

The projection 11 is not limited to be formed in the triangular shape at the entire end portion and may be formed in the triangular shape only in the center. FIG. 16 is a plan view showing a part of the configuration of a magnet body 110e in a modification. The magnet body 110e in the modification is assembled by fitting first magnets 10a4 and 10b4, a part of both end portions in the circumferential direction T of which is formed in a convex triangular shape, and a second magnet 20d, a part of both end portions in the circumferential direction T of which is formed in a concave triangular shape. The projection 611 in the radial gap motor 600 explained in the above modification may be formed in the same shape.

First magnets 10a5 and 10b5 and a second magnet 20e may be formed in a convex triangular shape on one side in the circumferential direction T and formed in a concave triangular shape on the other side in the circumferential direction T. FIG. 17 is a plan view showing a part of the configuration of a magnet body 110f in a modification. With this configuration, when an array is determined like the Halbach array, it is easy to assemble the magnet body 110f. The projection 611 in the radial gap motor 600 explained in the above modification may be formed in the same shape.

What is claimed is:

1. An axial gap motor comprising:
a stator including a coil; and
a rotor disposed to be separated from the stator and configured to rotate around a rotating shaft, wherein
the rotor includes a first magnet and a second magnet adjacent to the first magnet,
the first magnet includes a projection provided at an end portion in a circumferential direction in a plan view from an axial direction of the rotating shaft, and
the second magnet includes a recess provided at an end portion in the circumferential direction in the plan view from the axial direction and fitting with the projection.

2. The axial gap motor according to claim 1, wherein the projection is formed in a triangular shape formed by crossing at least two straight lines.

3. The axial gap motor according to claim 1, wherein the projection is formed in a trapezoidal shape.

4. The axial gap motor according to claim 1, wherein an imaginary line connecting a center of gravity of the first magnet and a center of gravity of the second magnet is formed in a substantially circular shape in the plan view from the axial direction.

5. The axial gap motor according to claim 1, wherein
the first magnet is a main magnetic pole magnet, and a pair of the projections are provided at both end portions in the circumferential direction of the first magnet, and
the second magnet is a sub-magnetic pole magnet, and a pair of the recesses are provided at both end portions in the circumferential direction of the second magnet.

6. A radial gap motor comprising:
a stator including a coil; and
a rotor disposed to be separated from the stator and configured to rotate around a rotating shaft, wherein
the rotor includes a first magnet and a second magnet adjacent to the first magnet,
the first magnet includes a projection provided at an end portion in a circumferential direction in a plan view from a radial direction of the rotating shaft, and
the second magnet includes a recess provided at an end portion in the circumferential direction in the plan view from the radial direction and fitting with the projection.

7. The radial gap motor according to claim 6, wherein the projection is formed in a triangular shape formed by crossing at least two straight lines.

8. The radial gap motor according to claim 6, wherein the projection is formed in a trapezoidal shape.

9. The radial gap motor according to claim 6, wherein an imaginary line connecting a center of gravity of the first magnet and a center of gravity of the second magnet is formed in a linear shape in the plan view from the radial direction.

10. The radial gap motor according to claim 6, wherein
the first magnet is a main magnetic pole magnet, and a pair of the projections are provided at both end portions in the circumferential direction of the first magnet, and
the second magnet is a sub-magnetic pole magnet, and a pair of the recesses are provided at both end portions in the circumferential direction of the second magnet.
